(19) United States
(12) Patent Application Publication
(10) Pub. No.: US 2008/0000089 A1
(43) Pub. Date: Jan. 3, 2008

(54) Multi-use shaving implement

(75) Inventors: Andrew J. Pennella, Stamford, CT (US); Armin Bartschi, Winznau (CH); Franz Fischer, Triengen (CH); Philipp Pfenniger, Triengen (CH)

Correspondence Address: MICHAUD-DUFFY GROUP LLP, 306 INDUSTRIAL PARK ROAD, SUITE 206, MIDDLETOWN, CT, 06457, US

(73) Assignee: Eveready Battery Company, Inc., St. Louis, MO (US)

(21) Appl. No.: 11/650,258

(22) Filed: Jan. 5, 2007

Related U.S. Application Data
(60) Provisional application No. 60/756,918, filed on Jan. 5, 2006.

(51) Int. Cl. B26B 19/00

(52) U.S. Cl. 30/34.1; 30/45; 30/50

(57) ABSTRACT

A multi-use shaving implement includes an elongated handle and swappable razor cartridge and trimmer head. The elongated handle has a powered motor that is at least partially located therein. The razor cartridge has at least one elongated blade with a sharpened cutting edge and is removably attachable to the handle. The trimmer head has at least one stationary blade, one movable blade and is also removably attachable to the handle when the razor cartridge is not attached to the handle. The trimmer head also includes a prong that extends therefrom. During use of the trimmer, the motor (when activated) is in contact with the prong such that the motor reciprocally moves the prong and, accordingly, the movable blade relative to the stationary blade, thus enabling the user to trim hair.

### CROSS-REFERENCE TO RELATED APPLICATION

This application claims the benefit of U.S. Provisional Patent Application No. 60/756,918, entitled “MULTI-USE SHAVING IMPLEMENT,” filed on Jan. 5, 2006, which is hereby incorporated herein by reference.

### FIELD OF THE INVENTION

The present invention is generally directed to shaving implements in general, and to shaving implements employing swappable razor cartridges and trimmer head in particular.

### BACKGROUND OF THE INVENTION

Most prior art shaving implements, also commonly known as wet shave razors, include a razor cartridge and a handle. The razor cartridge typically includes at least one blade positioned aft of a guard bar and forward of a cap. During use, the razor cartridge is mounted on a handle such that it can pivot relative to the handle between a neutral position and a rotated position.

The prior art razors described above are quite useful for shaving a surface short hair, or stubble, from a surface. However, they are not as useful for maintaining, shaping and/or trimming longer hair (e.g., mustaches, goatees, sideburns, and/or body hair). Various types of shaving devices other than wet shave razors, such as trimmers, are known to have particular utility for such uses. Trimmers typically operate through the use of two (2) adjacent blades that move relative to one another. One blade is reciprocally moved back and forth by a motor, and the other blade remains stationary. Each blade has a series of teeth that operate to cut hair in a scissoring fashion as the teeth of the moving blade move past the teeth of the stationary teeth when the motor is turned on.

Some devices have been disclosed that combine wet shave razors and trimmers. These devices typically include a trimmer that is permanently attached to the handle and movable between a use position and a non-use position. However, each of the prior art devices has inherent drawbacks. For example, some embodiments require the user to either hold the handle upside down, or backwards, when using the trimmer. Other embodiments have the trimmer permanently positioned on the handle in a precarious position, where the trimmer could be accidentally broken when the shaving device is stored or transported. Even further embodiments require the handle to be exceptionally large and/or unbalanced.

Based on the foregoing, it is therefore desirable to provide a razor cartridge and a shaving implement that overcomes the aforementioned problems and drawbacks associated with the prior art.

### SUMMARY OF THE INVENTION

According to one aspect of the present invention, a multi-use shaving implement includes an elongated handle and swappable razor cartridge and trimmer head. The elongated handle has a first connector and a powered motor that is at least partially located within the handle. The razor cartridge has at least one elongated blade with a sharpened cutting edge and a second connector complimentary to the first connector of the handle. The second connector enables a user to removably attach the razor cartridge to the handle. The trimmer head has at least one stationary blade, one movable blade and a third connector complimentary to the first connector of the handle. The third connector enables the user to removably attach the trimmer head to the handle when the razor cartridge is not attached to the handle. The trimmer head also includes a prong that extends therefrom. During use of the trimmer, the motor (when activated) is in contact with the prong such that the motor reciprocally moves the prong and, accordingly, the movable blade relative to the stationary blade. The relative motion of the two blades enables the user to trim the desired hair.

According to another aspect of the invention, the razor cartridge, when attached to the first connector, is pivotable relative to the handle.

According to a further aspect of the present invention, the trimmer cartridge, when attached to the first connector, is not pivotable relative to the handle.

According to an even further aspect of the present invention, each of the blades of the trimmer head includes a series of teeth.

The advantages of the present invention will be apparent to one of skill in the art in light of at least the above summary, the included drawings, and the detailed description of the invention.

### BRIEF DESCRIPTION OF THE DRAWINGS

FIG. 1 is an isometric view of a razor cartridge attached to a handle according to one embodiment of the present invention;

FIG. 2 is an isometric view of a trimmer head attached to a handle according to one embodiment of the present invention;

FIG. 3 is a front view of the razor cartridge;

FIG. 4 is an isometric view of the trimmer head; and

FIG. 5 is a lengthwise cross-sectional view taken through line V-V of FIG. 2.

### DETAILED DESCRIPTION OF THE INVENTION

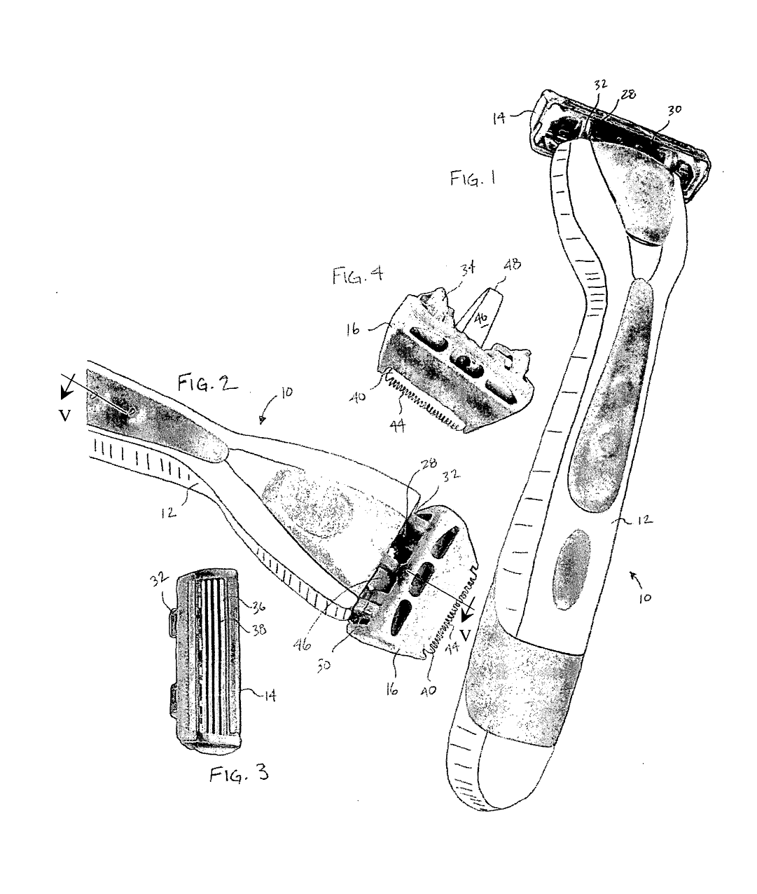

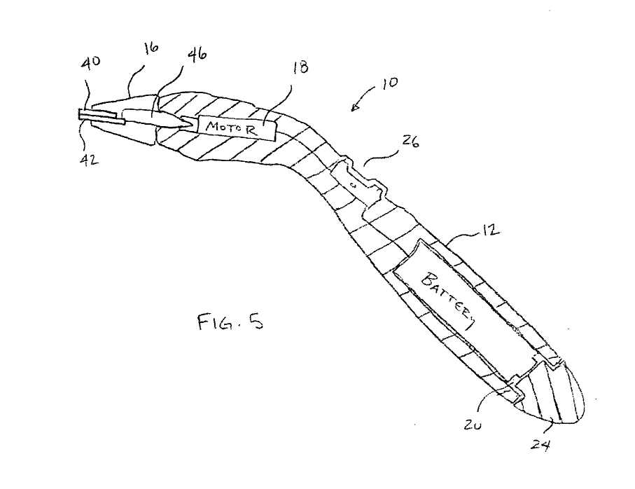

Referring to the FIGS. 1-5, the multi-use shaving device 10 of the present invention includes a handle 12, a razor cartridge 14, and a trimmer head 16. The razor cartridge 14 and the trimmer head 16 are removably attachable at separate times to the handle 12. The multi-use shaving device 10 of the present invention can be utilized by a user as either a wet shave razor (see FIG. 1) by removably attaching the razor cartridge 14 to the handle 12, or as a powered trimmer (see FIG. 2) by detaching the razor cartridge 14 and removably attaching the trimmer head 16 to the handle 12.

Referring now to FIGS. 1 and 5, the handle 12 is elongated and preferably ergonomically shaped to be easy for the user to manipulate in any one of many advantageous manners. An electrically powered motor 18 is at least partially located in the handle 12. In one embodiment, the handle 12 also includes a chamber 20 sized to house a battery 22 used to supply DC power to the motor 18. In the disclosed embodiments, the chamber 20 can have a cap 24 so that the battery 22 can be selectively replaced. Alternatively, the chamber 20 can be closed such that the handle 12 is intended to be replaced once the battery 22 has expired. However, the present invention should not be considered to be limited to DC battery power. The motor 18 of the present invention can be powered by any means, such as through the use of a power cord (not shown) intended to be plugged into an outlet to supply DC power. The motor 18 can be selectively turned on or off by a switch 26. The present invention can utilize any one of the known types of switches 26 (e.g., push button switch, toggle switch, slide switch).

The handle 12 also includes a first connector 28 located at one end of the handle 12. The first connector 28 may include any suitable connecting means. According to one embodiment, the first connector 28 includes a pair of arms 30 with outward projections that connect with complimentary second and third connectors 32, 34 located on the razor cartridge 14 and trimmer head 16, respectively (both discussed infra.). According to one embodiment, the second and third connectors 32 and 34 may each include a pair of slots that receive the outward projections of arms 30 to form a shell-bearing type docking system. However, the first connector 28 and second and third connectors 32 and 34 should not be considered to be so limited and can be of any suitable type known to those of skill in the art.

The razor cartridge 14 includes at least one elongated blade 36 that has a sharpened cutting edge 38. In one embodiment, the razor cartridge 14 includes a plurality of parallel elongated blades 36 mounted to a housing of the cartridge 14. In the embodiment shown, razor cartridge 14 has four parallel elongated blades 36. The razor cartridge 14 also includes a guard 50 located forward of the elongated blades 36 and a cap 52 located rearward of the elongated blades 36. The cap 52 may include a lubricating strip 54.

The razor cartridge 14 also includes a second connector 32 that enables the user to removably attach the razor cartridge 14 to the handle 12. Any suitable connecting means may be employed as the connector to matingly and releasably engage the first connector 28. In a preferred embodiment, the second connector 32 is complimentary to the shell bearing arms 30 of the first connector 28 discussed above such that the razor cartridge 14 is pivotable relative to the handle 12 when connected; however, the second connector 32 should not be considered to be so limited and can be of any suitable type known to those of skill in the art. For example, in some embodiments, it may be desirable for the razor cartridge 14 to not be pivotable relative to the handle 12.

The trimmer head 16 includes one stationary trim blade 40 and one movable trim blade 42, according to one embodiment. Either or both of trim blades 40 and 42 may be movably actuated such that blade 40 is moved relative to blade 42, according to other embodiments. The two (2) trim blades 40 and 42 are positioned adjacent one another and each includes sharpened teeth 44 that are able to trim hair in a scissoring action. The scissoring action is created when the teeth 44 of the movable blade 42 are reciprocally moved back and forth relative to the teeth 44 of the stationary blade 40. The trimmer head 16 shown in FIGS. 2 and 4 is merely exemplary. The number and size of the teeth 44 may vary greatly depending on a number of factors, including, for example, the power of the motor 18 located in the handle 12.

The trimmer head 16 further includes a prong 46. The prong 46 extends from the trimmer head 16, as shown in FIG. 4, and is received by the handle 12, as shown in FIG. 2. During use of the trimmer head 16, the prong 46 is in contact with the motor 18. Although the prong 46 is shown as having a single rounded point 48, the prong 46 can be of any suitable shape and size. For example, and although not shown, the prong 46 can have multiple tips (not shown) and/or be asymmetrical to assist the user in properly attaching the trimmer head 16 to the handle 12 in the correct orientation. During use of the trimmer head 16, the motor 18 (when activated) reciprocally moves the prong 46 back and forth. The prong 46, in turn, moves the movable blade 40 in a similar fashion, which creates the scissoring action necessary for trimming hair.

Alternatively, and although not shown, the prong 46 can be coupled to the motor 18 and extend from the handle 12. In this embodiment, the prong 46 is located substantially near the first connector 28 at a location where it will be in contact with the trimmer head 16 when the trimmer head 16 is attached to the handle 12. The prong 46 can be of any suitable shape or size; however, because the prong 46 is attached to the handle 12 in these instances, it is preferable that the prong 46 be of a size and shape that does not interfere with the pivoting action of the razor cartridge 14 when the shaving device 10 is utilized as a wet shave razor.

The trimmer head 16 further includes a third connector 34 which may be suitable connecting means to matingly and releasably engage the first connector 28. The third connector 34 is complimentary to the first connector 28 and enables the user to removably connect the trimmer head 16 to the handle 12 when the razor cartridge 14 is not in place. In one embodiment, the third connector 34 is complimentary to the shell bearing arms 30 of the first connector discussed above. However, the third connector 34 should not be considered to be so limited and can be of any appropriate type of connector complimentary to the first connector 28. In one embodiment, the trimmer head 16 is not pivotable relative to the handle 12. Typically, the prong 46 extending into (or out of) the handle 12 is sufficient to prevent the trimmer head 16 from pivoting relative to the handle 12 during use. However, the trimmer head 16 can optionally include stops (not shown) that prevent the trimmer from pivoting. Stops can also relieve strain and assist in preventing breakage of the prong 46 during use.

It should be further noted that the trim blades 40 and 42 of the trimmer head 16 may be at any angle relative to the handle 12 depending on the desired orientation of the blades 40 and 42 of the trimmer head 16 during use. The trimmer head 16 depicted in FIGS. 2, 4 and 5 is merely exemplary of one preferred angle for use with the particular handle 12 shown.

During typical use, the user removably attaches the second connector 32 of the razor cartridge 14 to the first connector 28 of the handle 12 and uses the shaving device 10 of the present invention as a typical wet shave razor. To removably attach or to selectively remove either the cartridge 14 or trimmer head 16, a user may depress a button 60 or other actuator to cause the first connector 28 to engage or disengage the second or third connectors 28 or 34. In one example, the button 60 may be depressed to cause arms 30 of first connector 28 to retract from the slots of either second or third connectors 32 or 34. Once the user has completed the shaving process, the razor cartridge 14 is selectively removed from the handle 12 and the user removably attaches the third connector 34 of the trimmer head 16 to the first connector 28 of the handle 12. The user then turns the motor 18 on. The motor 18 reciprocally moves the prong 46 back and forth. The prong 46, in turn, reciprocally moves the movable blade 42 back and forth relative to the stationary blade 40. As the movable blade 42 moves, the teeth 44 of the adjacent blades 40 and 42 create a scissoring action that enables the user to trim the desired hair (e.g., mustaches, goatees, side burns, and/or body hair). In addition, the user beneficially is able to trim hair while holding the shaving device 10 handle 12 in a manner substantially similar to the manner in which the handle 12 is held during normal wet shaving with the razor cartridge 14.

Modification and variations may be made to the disclosed embodiments without departing from the subject and spirit of the invention as defined by the following claims.

What is claimed is:

1. A multi-use shaving device, comprising:
an elongated handle having a first connector;
a powered motor that is at least partially located in the handle;
a razor cartridge having at least one elongated blade with a sharpened cutting edge, the razor cartridge also having a second connector complimentary to the first connector of the handle, the second connector enabling a user to removably attach the razor cartridge to the first connector of the handle; and
a trimmer head having at least a first trim blade, a second trim blade, and a third connector that is complimentary to the first connector of the handle, the third connector enabling the user to removably attach the trimmer head to the first connector of the handle when the razor cartridge is not attached to the handle;
wherein the motor is operatively coupled to the trimmer head when the trimmer head is attached to the handle such that the motor reciprocally moves at least one of the first and second trim blades relative to the other of the first and second trim blades when the motor is selective activated.

2. The multi-use shaving device of claim 1, wherein the motor is an electric motor powered by a battery that is located in the handle.

3. The multi-use shaving device of claim 1, wherein the second connector enable the razor cartridge to pivot relative to the handle during use.

4. The multi-use shaving device of claim 1, wherein the trimmer head includes stops that prevent the trimmer head from pivoting relative to the handle during use.

5. The multi-use shaving device of claim 1, wherein the first trim blade is a stationary blade and the second trim blade is a movable trim blade.

6. The multi-use shaving device of claim 5, wherein the stationary blade and the movable blade of the trimmer head both have teeth operable to trim hair when the movable blade is reciprocally moved back and forth during use.

7. The multi-use shaving device of claim 1, wherein the first and second trim blades each comprises teeth operable to trim hair when the first trim blade moves relative to the second trim blade.

8. The multi-use shaving device of claim 1, wherein the trimmer head further comprises a prong in contact with the motor such that the motor reciprocally moves the prong to move at least one of the first and second trim blades.

9. The multi-use shaving device of claim 8, wherein the first connector is located at one end of the elongated handle.

10. The multi-use shaving device of claim 1, wherein the first connector comprises a pair of arms and the second and third connectors each comprises a pair of slots that cooperatively receive the pair of arms to form a shell bearing connection.

11. The multi-use shaving device of claim 1, wherein the razor cartridge comprises a plurality of elongated blades.

12. The multi-use shaving device of claim 1, wherein the razor cartridge further comprises a guard in a cap, wherein the at least one elongated blade is located between the guard and the cap.

13. A multi-use shaving device, comprising:
an elongated handle having first connecting means;
a powered motor that is at least partially located in the handle;
a razor cartridge having at least one elongated blade with a sharpened cutting edge, the razor cartridge also having second connecting means complimentary to the first connecting means of the handle, the second connecting means enabling a user to removably attach the razor cartridge to the first connecting means of the handle; and
a trimmer head having at least one stationary blade, one movable blade and third connecting means that are complimentary to the first connecting means of the handle, the third connecting means enabling the user to removably attach the trimmer head to the first connecting means of the handle when the razor cartridge is not attached to the handle, the trimmer head also includes a prong that extends therefrom;
wherein the motor is in contact with the prong such that the motor reciprocally moves the prong and, accordingly, the movable blade relative to the stationary blade when the motor is selective activated.

14. The multi-use shaving device of claim 1, wherein the motor is powered by a battery. that is located in the handle.

15. The multi-use shaving device of claim 1, wherein the second connecting means enable the razor cartridge to pivot relative to the handle during use.

16. The multi-use shaving device of claim 1, wherein the trimmer head includes stops that prevent the trimmer head from pivoting relative to the handle during use.

17. The multi-use shaving device of claim 1, wherein the stationary blade and the movable blade of the trimmer head both have teeth operable to trim hair when the movable blade is reciprocally moved back and forth during use.

18. The multi-use shaving device of claim 13, wherein the first connecting means is located at one end of the elongated handle.

19. The multi-use shaving device of claim 13, wherein the first connecting means comprises a pair of arms and the second and third connecting means each comprises a pair of slots that cooperatively receive the pair of arms to form a shell bearing connection.

20. The multi-use shaving device of claim 1, wherein the razor cartridge comprises a plurality of elongated blades.

21. The multi-use shaving device of claim 1, wherein the razor cartridge further comprises a guard in a cap, wherein the at least one elongated blade is located between the guard and the cap.
